(19) United States
(12) Patent Application Publication
(10) Pub. No.: US 2017/0101572 A1
(43) Pub. Date: Apr. 13, 2017

(54) DEGRADATION AGENT ENCAPSULATION

(71) Applicant: SCHLUMBERGER TECHNOLOGY CORPORATION, Sugar Land, TX (US)

(72) Inventors: Meng Qu, Waltham, MA (US); Shitong S. Zhu, Waban, MA (US); Martin E. Poitzsch, Houston, TX (US); John David Rowatt, Harvard, MA (US)

(21) Appl. No.: 15/316,058

(22) PCT Filed: Jun. 1, 2015
(86) PCT No.: PCT/US2015/033458

§ 371 Date: Dec. 2, 2016

Related U.S. Application Data
(60) Provisional application No. 62/006,574, filed on Jun. 2, 2014.

(51) Int. Cl. C09K 8/03; C09K 8/035; E21B 41/00; C09K 8/70

(52) U.S. Cl. CPC C09K 8/032; C09K 8/70; C09K 8/035; E21B 41/00

(57) ABSTRACT

Degradation agent encapsulation is provided. In one possible implementation, a capsule includes a degradation agent configured to encourage degradation of the part and a coating at least partially encapsulating the degradation agent. The coating is engineered to be compromised upon exposure to one or more activation triggers. In another possible implementation, a degradable part includes one or more capsules embedded in the part. The capsules include a degradation agent at least partially encapsulated in a coating engineered to be compromised upon exposure to one or more activation triggers.

### RELATED APPLICATIONS

This application claims the benefit of U.S. Provisional Application having Ser. No. 62/006574 entitled “ENCAPSULATION OF DEGRADATION AGENTS” filed Jun. 2, 2014, which is incorporated by reference herein.

### BACKGROUND

In some instances, it may be desirable for a part to provide a certain functionality for a limited period of time. For example, in a downhole environment, such as in an oilfield application, certain parts may be useful during a well completion phase, but undesirable during a production phase. This can pose a unique problem, since retrieval of such parts from a downhole environment can be both time intensive and costly. For example, when a part exists in a complex downhole structure, disengaging the part, and bringing it to the surface without damaging other components in the well, can be both difficult and risky.

One current attempt at a solution is to use parts made from degradable materials. However such materials can often be ill-suited for such a purpose since they degrade too slowly in some downhole environments, leaving parts in position well past their desired period of functionality.

### SUMMARY

Degradation agent encapsulation is provided. In one possible implementation, a capsule includes a degradation agent configured to encourage degradation of a part, and a coating at least partially encapsulating the degradation agent. The coating is engineered to be compromised upon exposure to one or more activation triggers.

In another possible implementation, a part configured for use in a downhole environment includes one or more capsules embedded in the part. The capsules include a degradation agent at least partially encapsulated in a coating engineered to be compromised upon exposure to one or more activation triggers.

In another possible implementation, one or more capsules including a degradation agent at least partially encapsulated in a coating can be deployed in a degradable part. The capsules can be exposed to an activation trigger designed to compromise the coating such that the degradable part becomes exposed to the degradation agent.

This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example wellsite in which embodiments of degradation agent encapsulation can be employed;

FIG. 2 illustrates various example capsules that can be used in accordance with various implementations of degradation agent encapsulation;

FIGS. 3-5 illustrate various example methods of compounding capsules in a downhole part in order to degrade the part in accordance with implementations of degradation agent encapsulation;

FIG. 6 illustrates example methods of deploying capsules in a downhole environment to degrade a part in accordance with implementations of degradation agent encapsulation; and

FIG. 7 illustrates an example method associated with degradation agent encapsulation.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

Additionally, some examples discussed herein involve technologies associated with the oilfield services industry. It will be understood however that the techniques of degradation agent encapsulation may also be useful in a wide range of industries outside of the oilfield services sector, including for example, mining, geological surveying, medical imaging, etc.

As described herein, various techniques and technologies associated with degradation agent encapsulation can be utilized to facilitate the degradation of a part. For example, in one possible implementation, a degradation agent can be at least partially encapsulated in a coating to form a capsule. In one possible implementation, the coating can be degraded when desired by exposure to an activation trigger (such as exposure to a certain fluid, chemical, temperature, pH, mechanical force, etc.). Once the coating is compromised, the degradation agent can begin degrading of the part. In one possible implementation, capsules can be placed in a fluid surrounding the part. In another possible implementation, capsules can be placed inside the part to be degraded.

### Example Wellsite

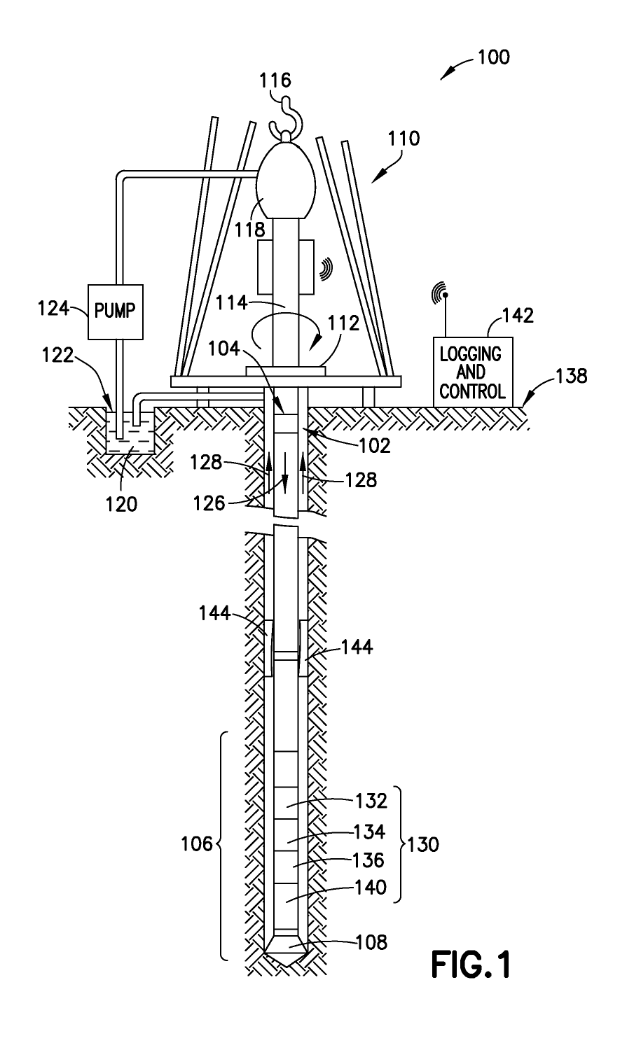

FIG. 1 illustrates a wellsite 100 in which embodiments of degradation agent encapsulation can be employed. Wellsite 100 can be onshore or offshore. In this example system, a borehole 102 is formed in a subsurface formation by rotary drilling in a manner that is well known. Embodiments of degradation agent encapsulation can also be employed in association with wellsites where directional drilling is being conducted.

A drill string 104 can be suspended within borehole 102 and have a bottom hole assembly 106 including a drill bit 108 at its lower end. The surface system can include a platform and derrick assembly 110 positioned over the borehole 102. The assembly 110 can include a rotary table 112, kelly 114, hook 116 and rotary swivel 118. The drill string 104 can be rotated by the rotary table 112, energized by means not shown, which engages kelly 114 at an upper end of drill string 104. Drill string 104 can be suspended from hook 116, attached to a traveling block (also not shown), through kelly 114 and a rotary swivel 118 which can permit rotation of drill string 104 relative to hook 116. As is well known, a top drive system can also be used.

In the example of this embodiment, the surface system can further include drilling fluid or mud 120 stored in a pit 122 formed at wellsite 100. A pump 124 can deliver drilling fluid 120 to an interior of drill string 104 via a port in swivel 118, causing drilling fluid 120 to flow downwardly through drill string 104 as indicated by directional arrow 126. Drilling fluid 120 can exit drill string 104 via ports in drill bit 108, and circulate upwardly through the annulus region between the outside of drill string 104 and wall of the borehole 102, as indicated by directional arrows 128. In this well-known manner, drilling fluid 120 can lubricate drill bit 108 and carry formation cuttings up to the surface as drilling fluid 120 is returned to pit 122 for recirculation.

Bottom hole assembly 106 of the illustrated embodiment can include drill bit 108 as well as a variety of equipment 130, including a logging-while-drilling (LWD) module 132, a measuring-while-drilling (MWD) module 134, a roto-steerable system and motor, various other tools, etc.

In one possible implementation, LWD module 132 can be housed in a special type of drill collar, as is known in the art, and can include one or more of a plurality of known types of logging tools (e.g., a nuclear magnetic resonance (NMR system), a directional resistivity system, and/or a sonic logging system). It will also be understood that more than one LWD and/or MWD module can be employed (e.g. as represented at position 136). (References, throughout, to a module at position 132 can also mean a module at position 136 as well). LWD module 132 can include capabilities for measuring, processing, and storing information, as well as for communicating with surface equipment.

MWD module 134 can also be housed in a special type of drill collar, as is known in the art, and include one or more devices for measuring characteristics of the well environment, such as characteristics of the drill string and drill bit. MWD module 134 can further include an apparatus (not shown) for generating electrical power to the downhole system. This may include a mud turbine generator powered by the flow of drilling fluid 120, it being understood that other power and/or battery systems may be employed. MWD module 134 can include one or more of a variety of measuring devices known in the art including, for example, a weight-on-bit measuring device, a torque measuring device, a vibration measuring device, a shock measuring device, a stick slip measuring device, a direction measuring device, and an inclination measuring device.

Various systems and methods can be used to transmit information (data and/or commands) from equipment 130 to a surface 138 of the wellsite 100. In one implementation, information can be received by one or more sensors 140. The sensors 140 can be located in a variety of locations and can be chosen from any sensing and/or detecting technology known in the art, including those capable of measuring various types of radiation, electric or magnetic fields, including electrodes (such as stakes), magnetometers, coils, etc.

In one possible implementation, sensors 140 receive information from equipment 130, including LWD data and/or MWD data, which can be utilized for a variety of purposes including steering drill bit 108 and any tools associated therewith, characterizing a formation surrounding borehole 102, characterizing fluids within wellbore 102, etc.

In one implementation a logging and control system 142 can be present. Logging and control system 142 can receive and process a variety of information from a variety of sources, including equipment 130. Logging and control system 142 can also control a variety of equipment, such as equipment 130 and drill bit 108.

Logging and control system 142 can also be used with a wide variety of oilfield applications, including logging while drilling, artificial lift, measuring while drilling, wireline, etc. Also, logging and control system 142 can be located at surface 138, below surface 138, proximate to borehole 102, remote from borehole 102, or any combination thereof.

Alternately, or additionally, information received by sensors 140 can be processed at one or more other locations, including any configuration known in the art, such as in one or more handheld devices proximate and/or remote from the wellsite 100, at a computer located at a remote command center, in the logging and control system 142 itself, etc.

In one possible implementation, once borehole 102 has been drilled various post drilling equipment 144 can be placed at various locations in borehole 102. Post drilling equipment 144 can include anything that might be helpful in producing a desired outcome in borehole 102, such as, for example, packers, filter elements, control systems, valves, pumps, devices/tools for zonal isolation, etc.

### Example System(s)

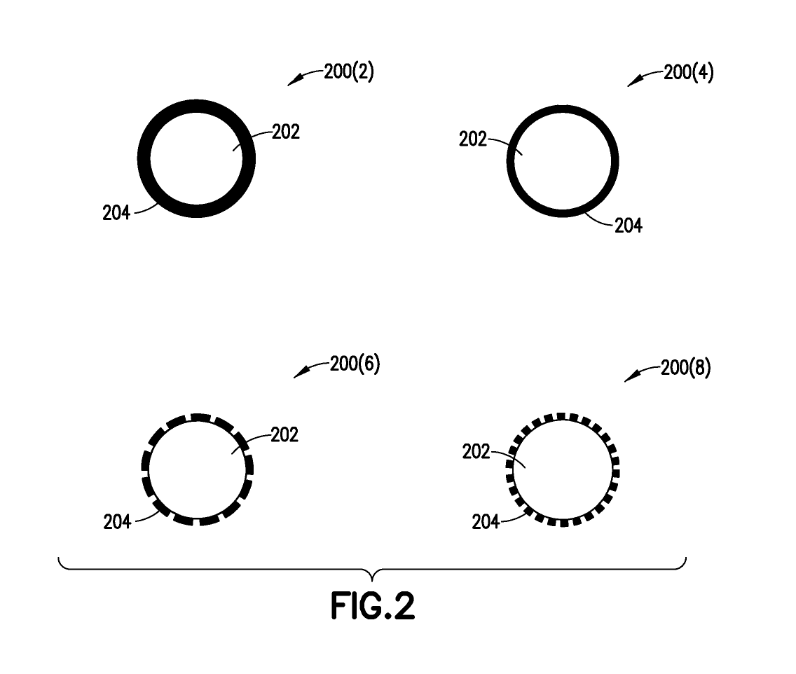

FIG. 2 illustrates example capsules 200 that can be used in accordance with various implementations of degradation agent encapsulation. Capsules 200 can include a degradation agent 202 at least partially encapsulated by a coating 204. Once released by coating 204, degradation agent 202 can degrade a material of interest by encouraging dissolution, cracking, fragmentation, etc., of the material. The term “degradation” as used herein includes triggering degradation (including catalyzing degradation) and accelerating degradation which may already be taking place.

In one possible implementation, a rate of degradation of the material of interest can be controlled by engineering coating 204 to release degradation agent 202 at a desired time, rate, etc.

Degradation agent 202 can be of any phase, and can include any chemical(s) and/or catalyst(s) (including any combination thereof) useful in helping to trigger and/or accelerate a degradation rate of the material of interest. The material of interest can include any degradable material known in the art, such as, for example, degradable polymers (including, for example polyester, polyamide, polyurethane, etc.), polymer composites, and degradable metal and metal alloys.

In one possible implementation, degradation agent 202 can include Lewis acids (such as ZnCl₂, AlCl₃, GaCl₃, BF₃, BCl₃, AlF₃, ZnF₂, etc.). Degradation agent 202 can also include base precursors and/or metal oxides such as MgO, CaO, ZnO, Ca(OH)₂, Al₂O₃, Mg(OH)₂, etc.

In one possible embodiment, coating 204 can function as a clocking agent, releasing degradation agent 202 at a desired time. For example, coating 204 can degrade upon exposure to one or more activation triggers including, for example, mechanical triggers (including physical triggers), predetermined fluids, and/or predefined levels of heat, pH, chemical(s), etc. For example, in one possible implementation, coating 204 can be engineered to begin to degrade when exposed to a given threshold temperature, such as, for instance, a temperature above 200 degrees Fahrenheit. In another possible implementation, coating 204 can begin to degrade when exposed to a given pH, such as, for example, a pH less than 5.8.

Coating 204 can be made from a wide variety of degradable materials. For example, coating 204 can include polymers which themselves include ester, amide and/or urethane bonds (such as, for example, polylactic acid (PLA), polyglycolic acid (PGA), polyethylene terephthalate (PET), polyurethane, polyamide, etc.). Coating 204 can also include epoxy, polyolefins, silicone, silanes, long chain fatty acids, esters of long chain fatty acids, fluoropolymers, polyvinyl alcohol (PVOH), modified PVOH, polyether ether ketone (PEEK), polyimides, wax, polyketone, polyacetal, metal based composites such as stainless steel particle filled polymer composite coatings, Zn particle filled coatings and rubber based coatings, etc.

Coating 204 can also be made from a wide variety of erosion and abrasion resistant materials (including non degradable materials), such as, for example, metallic materials including boron nitride (BN), titanium nitride (TiN), chromium nitride (CrN), tungsten carbide (WC), tungsten carbide/cobalt (WC/Co), tungsten carbide cobalt chrome (WCCoCr), chrome carbide (CrC),SiO₂, filler reinforced epoxy, etc.

Coating 204 can be created and/or deposited on degradation agent 202 using any technique known in the art including, for example, thermal spray based methods such as air plasma spray (APS), vacuum plasma spray (VPS), high velocity oxygen fuel spray (HVOF), high velocity air fuel spray (HVAF), aerosol spray, solvent spray, dipping, Langmuir-Blodgett trough (LB film) methods, spin coating, layer-by-layer deposition, chemical vapor deposition (CVD), physical vapor deposition (PVD), cold spray coating, etc.

Additionally, coating 204 can be created and/or deposited on degradation agent 202 using emulsion polymerization, mini-emulsion polymerization, interfacial polymerization, solvent evaporation, phase separation methods, etc.

Coating 204 can be engineered in any way possible to release degradation agent 202 as desired. For example, if a certain level of resistance to a given activation trigger is desired, a coating material (or combination of several coating materials) known to provide the desired level of resistance to the trigger can be chosen for coating 204.

Moreover a thickness and/or porosity of coating 204 can be varied depending on when and/or how degradation agent 202 is desired to be released. For instance, as shown in FIG. 2 a thickness of coating 204 on capsule 200(2) can be thicker than coating 204 on capsule 200(4). When similar materials are used for coating 204, and when capsules 200(2), 200(4) are subjected to the same activation triggers, coating 204 on capsule 200(2) can be more resistant to degradation than coating 204 on capsule 200(4) based on the greater thickness of coating 204 on capsule 200(2). In such a scenario, it can take longer to compromise coating 204 on 200(2) and thus degradation agent 202 in capsule 200(2) would be released later than would degradation agent 202 in capsule 200(4).

In another possible implementation, a porosity of coating 204 can be tuned to release degradation agent 202 as desired. The term “porosity” as used herein can include any openings in coating 204, including those associated with pores, defects, cracks, etc., in coating 204.

In one possible embodiment, such as, for example, in the case of non degradable coatings 204, a less porosity coating 204 on capsule 200(6) can delay release of degradation agent 202 relative to a more porous coating 204 on capsule 200(8). In one possible aspect, the lesser porosity of coating 204 on capsule 200(6) can make it more difficult for fluids to penetrate coating 204 and transport degradation agent 202 outside of capsule 200(6) than would be the case with the more porous coating 204 of capsule 200(8).

In one possible embodiment, the porosity of coating 204 (including density, size of pores, etc.) can be tuned in any way possible to allow for a compromise of coating 204 and the release of degradation agent 202 in any rate and/or manner desired.

In another possible implementation, when degradable coatings 204 are employed, the porosity of coating 204 (including density, size of pores, etc.) can be tuned in any way possible to allow for the release of degradation agent 202 when coating 204 is subjected to one or more activation triggers. For example, in the case of a chemical activation trigger, a more porous coating 204 could have more surface area in contact with a triggering chemical and therefore degrade more quickly (and release degradation agent 202 more quickly) than a less porous coating 204.

It will be understood that porosity and thickness of coatings 204 can be varied on their own, or in any combination possible, in order to tune coatings 204 to release degradation agent 202 in any manner desired.

It will be also understood that even though capsules 200 are illustrated in FIG. 2 as spheres, any other shapes or combination of shapes known in the art can be used. For example, capsules 200 having oblong shapes, cubic shapes, etc. can also be used.

Moreover, the size of capsules 200 can be varied as desired such that larger or smaller amounts of degradation agent 202 can be included in a capsule 200. Moreover, it will also be understood that a variety of different capsules 200 with different coatings and different degradation agents can be employed simultaneously as desired.

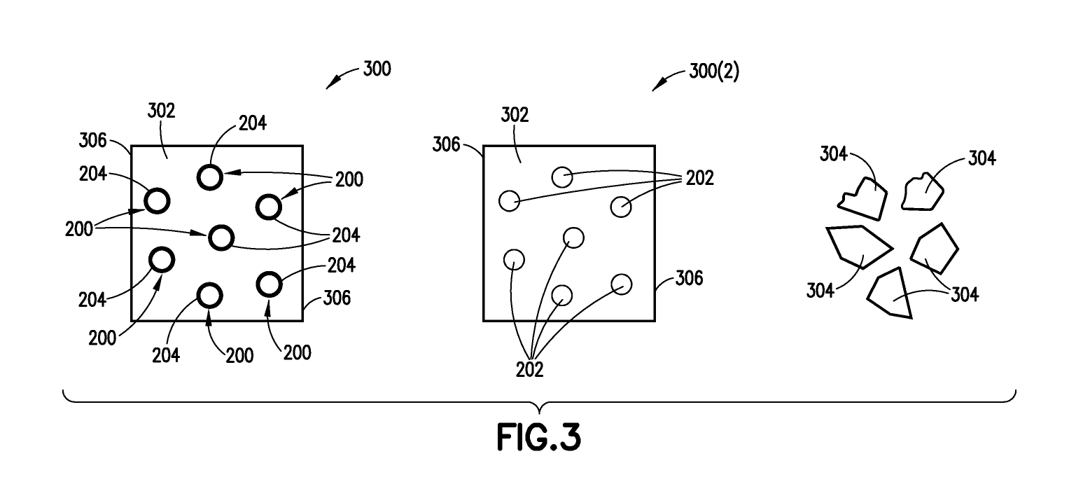

FIGS. 3-5 illustrate various example methods of compounding capsules 200 in a part 300, such that capsules 200 can be used to facilitate degradation of part 300 in accordance with implementations of degradation agent encapsulation. Part 300 can include anything that is desired to be degraded, including for example, any parts or components of equipment 144.

As shown in FIG. 3, one or more capsules 200 can be compounded into part 300 made of a material 302. In one possible implementation, material 302 can be a degradable material such as a degradable polymer and/or a polymer composite. Compounding of capsules 200 into part 300 can be accomplished using any known techniques in the art, including, for example, placing capsules 200 into material 302 before material 302 is fabricated into part 300.

In one possible implementation, it may be desirable to discontinue the functionality of part 300 and/or remove part 300 from a downhole environment at a given time. For example, once part 300 has performed its desired functionality, an operator may wish to degrade part 300 such that it can no longer function.

In one possible embodiment, degradation of part 300 can be accomplished by compromising coating 204 such that degradation agent 202 is released and placed in direct contact with material 302 of part 300. For example, coating 204 can be exposed to one or more activation triggers, such as, for example, mechanical triggers (including physical triggers), predetermined fluids, and/or predefined levels of heat, pH, chemical(s), etc., at which the material of coating 204 begins to degrade and/or an existing degradation of coating 204 begins to accelerate.

Part 302(2) illustrates such a condition, in which coatings 204 of one or more capsules 200 have degraded such that degradation agent 204 is in direct contact with material 302. Degradation of coating 204 can be complete or partial, and in one possible implementation coating 204 can be engineered to degrade at a given rate in order to tune the rate of release of degradation agent 202. In such a manner, a rate of degradation of material 302, and thus part 300, can be controlled.

In the case of porous coatings (including non degradable porous coatings), in one possible aspect, compromise of coating 204 (and thus the release of degradation agent 202) can be accomplished by exposing coating 204 to an activation trigger comprising a predefined fluid capable of penetrating the pores of coating 204. In this way, the predetermined fluid can interact with degradation agent 202 and transport it outside of capsule 200. Pore size, density, etc., of coating 204 can be engineered to tune the release of degradation agent 202 as desired.

In another possible implementation, a porous coating 204 can be compromised by both a fluid penetrating the pores of coating 204, and by exposure to one or more other activation triggers causing coating 204 itself to degrade.

Once degradation agent 202 comes into contact with material 302, material 302 will degrade and part 300 will be reduced to several pieces 304. In one possible implementation, the speed of degradation of part 300 can be influenced by the speed of degradation (and/or the degree or porosity) of coatings 204 on capsules 200 in part 300.

In another possible implementation, the speed of degradation of part 300 and/or the size of pieces 304 can be influenced by a density of capsules 200 in part 300. For example, if a quicker degradation of part 300 is desired and/or if smaller pieces 304 are desired, a greater number (and therefore density) of capsules 200 may be compounded into part 300.

Moreover, different densities of capsules 200 can be placed at various locations inside part 300 to tune a speed of degradation of those locations and/or tune a size of parts 304 into which those locations of part 300 degrade.

Additionally, different types of capsules 200 can be compounded into part 300 to tune a degradation of part 300 in any way desired. This can include utilizing capsules 200 of various sizes, capsules 200 having various types of degradation agents, and/or capsules 200 having various types of coatings 204 in part 300.

For example, to engineer a rapid degradation of part 300, capsules 200 farther from a surface 306 of part 300 can be engineered to release their encapsulated degradation agents 202 before capsules 200 closer to surface 306 do. For instance, capsules 200 far from surface 306 may have coatings 204 that begin degradation at a lower activation trigger threshold than coatings 204 of capsules 200 nearer to surface 306. For purposes of illustration, and not limitation, in one possible embodiment, if the activation trigger is temperature, capsules 200 far from surface 306 can have coatings 204 that begin degradation when exposed to a lower temperature than do coatings 204 of capsules 200 nearer to surface 306. In this way, capsules 200 deeper in part 300 will begin degrading and releasing their degradation agents 202 before capsules 200 closer to surface 306.

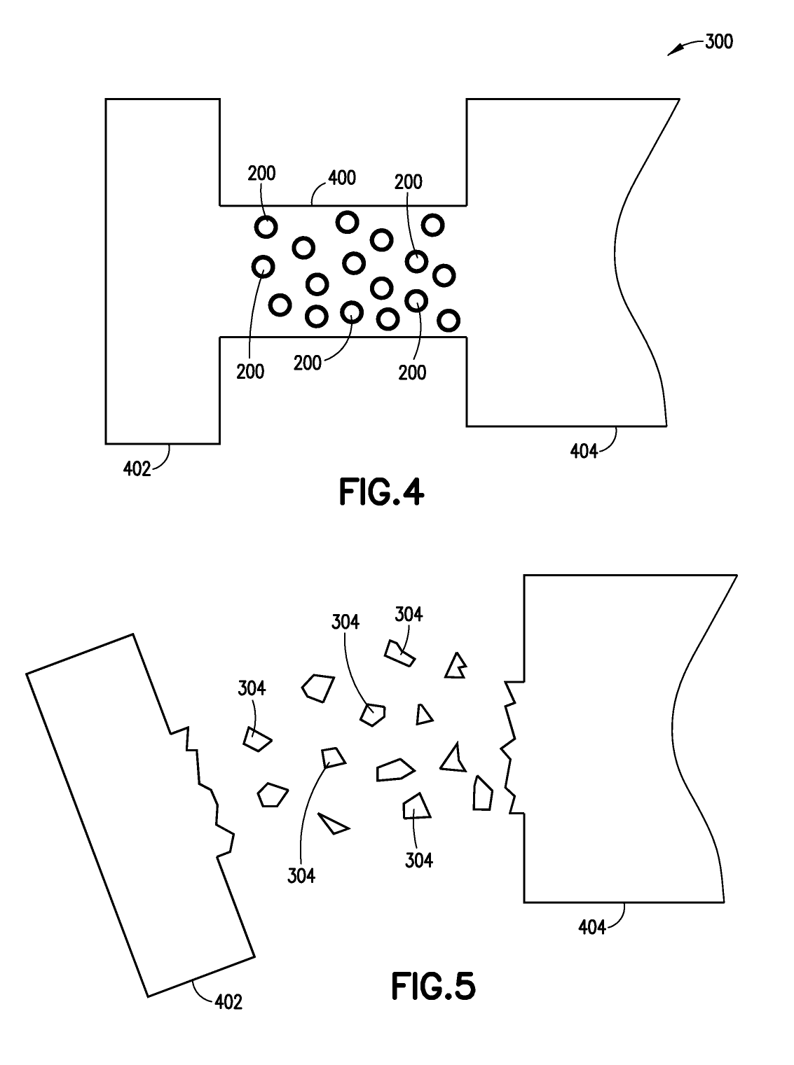

FIG. 4 illustrates a concentrated placement of capsules in a location 400 of part 300. The placement of capsules 200 in location 400 can be used to sever a portion 402 of part 300 when portion 402 is no longer desired, while leaving a portion 404 of part 300 in whatever downhole structure portion 404 might be a component.

In operation, once capsules 200 in location 400 are exposed to one or more activation triggers configured to compromise coatings 204 on capsules 200, degradation agents 202 in capsules 200 will be placed into contact with material 302 of part 300 in location 400. In one possible implementation, an activation trigger can include a fluid capable of penetrating a porous coating 204 to contact and transport a degradation agent 202 outside of coating 204.

As a result, once degradation agents 202 are placed into contact with material 302, material 302 in location 400 will begin degrading and/or accelerated degrading.

FIG. 5 illustrates part 300 after degradation has occurred in location 400. As shown, location 400 has degraded into multiple pieces 304 such that portion 402 has been separated from portion 404. In this way portion 402 can be removed from part 300, while portion 404 can remain attached to part 300.

In one possible implementation, capsules 200 can be placed in several other locations (other than location 400, such as for example, portion 402) of part 300, and be triggered at different times in order to effect a removal of different portions of part 300 at different times, as desired.

As discussed above, various types of capsules 200 can be compounded into location 400 to tune a degradation of location 400 in any way desired. This includes, for example, the use of capsules 200 having various sizes, degradation agents, and/or coatings (including varying resistance to one or more activation triggers). In addition capsules 200 can be employed in any density desired to affect degradation of location 400 at whatever speed desired and/or to create pieces 304 of whatever size desired.

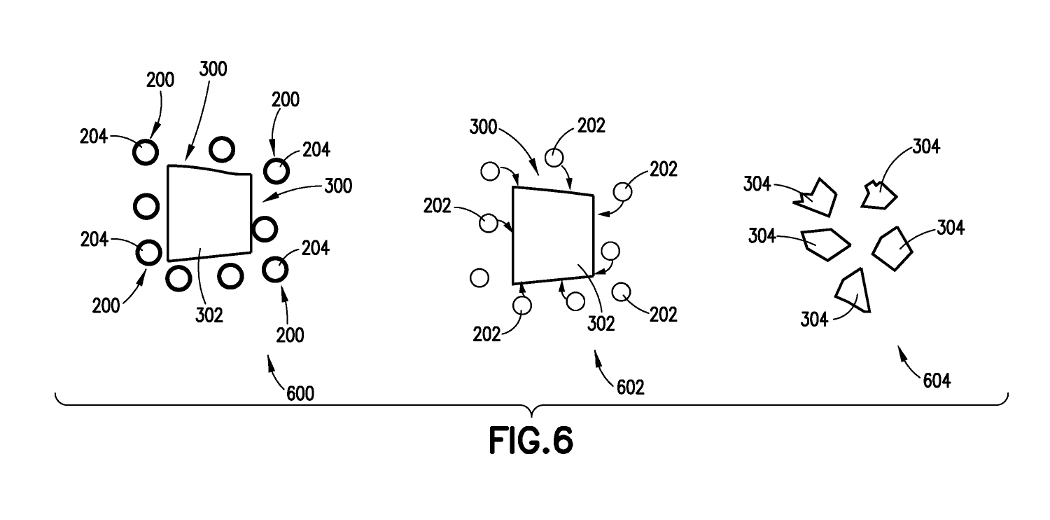

FIG. 6 illustrates another possible implementation of degradation agent encapsulation in which capsules 200 are deployed in a downhole environment to degrade part 300. As shown in scenario 600, capsules 200 can be deployed in proximity to part 300. Deployment of capsules 200 can be accomplished in any way known in the art, including injecting capsules 200 in one or more fluids in proximity to part 300, including fluids used for drilling, fracturing, completions, etc.

Scenario 602 illustrates one possible implementation in which capsules 200 are exposed to one or more activation triggers configured to degrade coatings 204. In such a scenario, degradation agents 202 are released from capsules 200 such that they are free to come into contact with part 300 and begin degradation of material 302. In one possible embodiment, degradation can continue at a rate commensurate with the amount and/or strength of degradation agent(s) 202 in contact with part 300, until part 300 is degraded into a plurality of pieces 304 (as shown in scenario 604).

Various types of capsules 200 can be deployed in proximity to part 300 to tune degradation of part 300 in any way desired. This can include, for example, the use of capsules 200 having various sizes, degradation agents, and/or coatings 204 (including porous coatings and coatings with varying resistance to one or more activation triggers). In addition capsules 200 can be employed in any concentration desired to affect degradation of part 300 at whatever rate desired and/or to create pieces 304 of whatever size desired.

Moreover, waves of capsules 204 with different configurations can be deployed at different times proximate to part 300 to tune degradation of part 300 in any manner desired.

Additionally, it will be understood that in some embodiments of degradation agent encapsulation, capsules 200 deployed in proximity to part 300 (in any of the manners described above) can be used with a part 300 having capsules 200 compounded therein, in any fashion described above. Such a hybrid approach can be tuned in any way possible to control degradation of part 300 in any way desired. For example, in one possible embodiment, capsules 200 compounded in part 300 can have different activation triggering levels than capsules 200 outside of part 300. Thus, different activation triggers can be used to compromise coatings 204 of capsules 200 inside part 300 and coatings 204 of capsules 200 outside of part 300 such that capsules 200 inside and outside of part 300 begin releasing their associated degradation agents 202 at different times.

### Example Methods

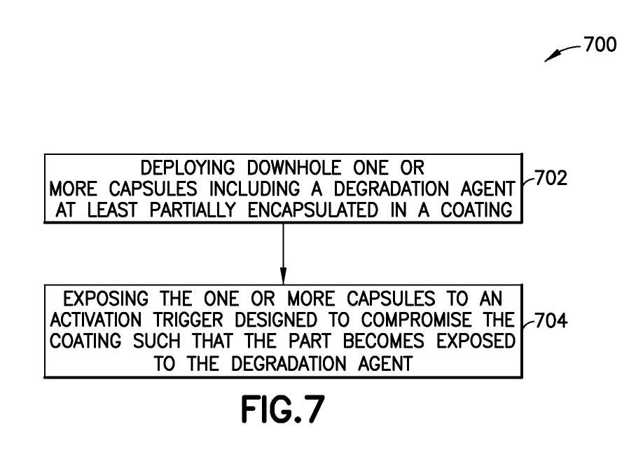

FIG. 7 illustrates example method(s) for implementing aspects of degradation agent encapsulation. The methods are illustrated as a collection of blocks and other elements in a logical flow graph representing a sequence of operations. The order in which the methods are described is not intended to be construed as a limitation, and any number of the described method blocks can be combined in any order to implement the methods, or alternate methods. Additionally, individual blocks and/or elements may be deleted from the methods without departing from the spirit and scope of the subject matter described therein. Moreover, for discussion purposes, and not purposes of limitation, selected aspects of the methods may be described with reference to elements shown in FIGS. 1-6.

At block 702, one or more capsules (such as capsules 200) including a degradation agent (such as degradation agent 202) at least partially encapsulated in a coating (such as coating 204) are deployed downhole.

In one possible implementation, the capsules are compounded into a part that may later be degraded. In another possible implementation, the capsules are deployed downhole by including them in various fluids that are transported downhole during activities such as drilling, fracking and/or completions, which come into contact with a part that may later be degraded.

In yet another possible implementation, capsules are both compounded into a part that may later be degraded and included in various fluids transported downhole during activities such as drilling, fracking and/or completions, which come into contact with the part.

A wide variety of capsules can be used, with varying degradation agents and coatings. In one possible implementation, a combination of capsules compounded in the part, their placement, their density, etc., can be engineered to tune a degradation of the part in any way desired.

At block 704, the one or more capsules are exposed to an activation trigger designed to compromise the coating such that the part becomes exposed to the degradation agent.

In one possible implementation, activation triggers include, for example, mechanical triggers (including physical triggers), predetermined fluids, and/or predefined levels of heat, pH, chemical(s), etc., and can compromise the coating by degrading it. For example, when a porous coating is used (including a non degradable porous coating), the activation trigger can include a fluid able to penetrate pores in the coating. Once the fluid penetrates the coating, the fluid can mix with the degradation agent and transport the degradation agent outside of the capsule where the degradation can contact and begin degrading the part.

In one possible implementation, different capsules can react to different activation triggers. In this way coatings of different capsules can be compromised at different times allowing for release of their corresponding degradation agents at predetermined times to tune degradation of the part in any desired way.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

1. A capsule configured to selectively encourage degradation of a part employed in a downhole environment, the capsule comprising:
a degradation agent configured to encourage degradation of the part; and
a coating at least partially encapsulating the degradation agent, wherein the coating is engineered to be compromised upon exposure to one or more activation triggers.

2. The capsule of claim 1, wherein the degradation agent includes one or more of:
a metal oxide;
a base precursor; and
a Lewis acid.

3. The capsule of claim 1, wherein the degradation agent is configured to degrade one or more of:
a degradable polymer; and
a polymer composite.

4. The capsule of claim 1, wherein the degradation agent includes a catalyst configured to instigate degradation of the part.

5. The capsule of claim 1, wherein the coating includes one or more of:
a wax; and
a degradable epoxy.

6. The capsule of claim 1, wherein a structural integrity of the coating against degradation by the one or more activation triggers can be determined by one or more of:
a thickness of the coating; and
a porosity of the coating.

7. The capsule of claim 1, wherein the one or more activation triggers comprise one or more of:
exposure to a predetermined level of temperature;
exposure to a predetermined level of mechanical force;
exposure to a predetermined level of pH;
exposure to a predetermined concentration of a chemical; and
exposure to a predetermined fluid.

8. A degradable part comprising:
one or more capsules embedded in the part, the capsules comprising a degradation agent at least partially encapsulated in a coating engineered to compromise upon exposure to one or more activation triggers.

9. The part of claim 8, wherein a resiliency of the coating to degrade when exposed to the one or more activation triggers, can vary among capsules embedded in the part.

10. The part of claim 9, wherein the resiliency of the coating to degrade when exposed to the one or more activation triggers varies among capsules embedded in the part to encourage uniform degradation of the part.

11. The part of claim 8, wherein a density of capsules embedded in the part can vary from one location to another in the part.

12. The part of claim 11, wherein a greater density of capsules in a first location of the part relative to a second location of the part can encourage degradation of the first location before degradation of the second location.

13. The part of claim 8, wherein a density of capsules in the part can be set to encourage the part to degrade into pieces below a preset size.

14. The part of claim 8, wherein a placement of the one or more capsules in the part can determine what one or more portions of the part degrade.

15. The part of claim 8, wherein a placement of the one or more capsules in the part determine what size of pieces the part degrades into.

16. A method of encouraging one or more portions of a downhole part to degrade comprising:
deploying downhole one or more capsules including a degradation agent at least partially encapsulated in a coating; and
exposing the one or more capsules to an activation trigger designed to compromise the coating such that the part becomes exposed to the degradation agent.

17. The method of claim 16, wherein the deploying comprises embedding the one or more capsules in the part.

18. The method of claim 17, wherein the deploying comprises embedding the one or more capsules at a first density in a first location of the part and a second density in a second location of the part.

19. The method of claim 16, wherein the deploying comprises placing the one or more capsules in a fluid in contact with the part.

20. The method of claim 16, wherein the exposing comprises exposing the one or more capsules to an activation trigger comprising one or more of:
a predetermined level of temperature;
a predetermined level of mechanical force;
a predetermined level of pH;
a predetermined concentration of a chemical; and
a predetermined fluid.
